(19) United States
(12) Patent Application Publication
(10) Pub. No.: US 2021/0060764 A1
(43) Pub. Date: Mar. 4, 2021

(54) ROBOTIC ARM END EFFECTOR

(71) Applicant: Laser Mechanisms, Inc., Novi, MI (US)

(72) Inventors: Tomas R. Kugler, Williamston, MI (US); Matt Brehmer, Novi, MI (US); Scott D. Swartzinski, Plymouth, MI (US); William G. Fredrick, Northville, MI (US); Gerry F. Hermann, Westland, MI (US)

(21) Appl. No.: 16/643,841

(22) PCT Filed: Aug. 31, 2017
(86) PCT No.: PCT/US2018/049138

§ 371 Date: Mar. 2, 2020

Related U.S. Application Data
(60) Provisional application No. 62/553,016, filed on Aug. 31, 2017.

(51) Int. Cl. B25J 9/02; B25J 19/00; B25J 9/12; B25J 9/10

(52) U.S. Cl. CPC B25J 9/023; B25J 9/102; B25J 9/123; B25J 19/002

(57) ABSTRACT

A robotic arm end effector for a laser head coupled to a robotic arm is disclosed. The end effector has a coupler to couple the end effector to the robotic arm and a first actuator assembly coupled to the first coupler. The first actuator has a first drive coupled to the laser cutting head and configured to move the laser cutting head along a first path. The first drive is coupled to a first counter mass and being configured to move the first counter mass along a second path in a direction opposite the first direction. The end effector also has a second actuator assembly coupled to the coupler. The second actuator has a second drive coupled to the laser head which is configured to move the laser head along a third path in a third direction.

### CROSS-REFERENCE TO RELATED APPLICATIONS

This application claims the benefit of PCT/US2018/049138, filed on Aug. 31, 2018 which claims the benefit of U.S. Provisional Application No. 62/553,016, filed on Aug. 31, 2017. The entire disclosure of the above application are incorporated herein by reference.

### FIELD

The present disclosure relates to a robotic laser cutting system and more particularly to an end effector for a laser cutting head.

### BACKGROUND

This section provides background information related to the present disclosure which is not necessarily prior art.

It is known to use fiber lasers to weld and cut materials along complex paths and geometries. To effectuate these complex geometries, a laser head is used to focus the cutting beam onto the material being cut. These laser heads are typically coupled onto a robotic arm to bring the laser head into position with respect to the material.

Unfortunately, due to the mass of the laser head, inertially induced movement of the head along the complex path often causes sympathetic vibrations within the supporting robotic arm. Theses sympathetic vibrations cause vibrational movement of the laser head, which can lead to errors in the surface cut. While not a satisfactory solution, to overcome these errors, programmers of the robotic are will typically reduce the speed of the robot, increasing manufacturing costs. It is an object of the invention to overcome the deficiencies of the prior art robotic arm supported laser cutting systems.

### SUMMARY

This section provides a general summary of the disclosure and is not a comprehensive disclosure of its full scope or all of its features.

According to the present teachings, a robotic arm end effector for a laser head coupled to a robotic arm is provided. The end effector has a coupler to couple the end effector to the robotic arm and a first actuator assembly coupled to the first coupler. The first actuator has a first drive coupled to the laser cutting head which is configured to move the laser cutting head along a first path. The first drive is coupled to a first counter mass which is configured to move the first counter mass along a second path in a direction opposite the first direction. The end effector also has a second actuator assembly coupled to the coupler. The second actuator has a second drive coupled to the laser head which is configured to move the laser head along a third path in a third direction. The second drive is coupled to a second counter mass which is configured to move the second counter mass in along a fourth path and in a direction opposite the third direction.

According to an alternate teaching for the afore or following mentioned systems, the first drive of the end effector has first and second variable speed linear actuators. These first and second variable speed linear actuators can be screw drives driven by the first and second drive stepper motors.

According to an alternate teaching for any of the afore or following mentioned systems, the mass of the counter mass can be equal to or a fraction of the mass of the laser cutting head.

According to an alternate teaching for any of the afore or following mentioned systems, the first drive is configured to move the laser cutting head a first distance along the first path and the second drive is configured to move the first counter mass along the second opposite path the first distance.

According to an alternate teaching for any of the afore or following mentioned systems, the first drive is configured to move the laser cutting head a first distance along the first path and the first drive is configured to move the first counter mass along the second path the second distance different than the first distance.

According to an alternate teaching for any of the afore or following mentioned systems, laser head module has a laser head center of gravity and the first counter mass has a first counter mass center of gravity. The laser head center of gravity and first counter mass center of gravity move on a first motion plane when on the laser head is moving in the first direction and the counter weight is moving in the second direction.

According to an alternate teaching, the laser head has a beam direction, the first and second paths are perpendicular to the beam direction.

According to an alternate teaching, the first and second paths are linear, while the path of the resultant path of the laser head is curved.

According to the present teachings, a robotic arm end effector for a laser head coupled to a robotic arm is provided. The end effector has a laser head and a drive mechanism having a first actuator assembly. The first actuator assembly is configured to move the laser head in along a first linear path in a first direction and further configured to move first counter mass in along a second linear path which is parallel to the first linear path in a second direction opposite first direction.

According to the present teachings, the afore or following mentioned systems can include a drive mechanism that has a stepper motor and the first actuator assembly is one of a screw drive, a rack and pinion.

According to the present teachings, the afore or following mentioned systems can include a second actuator assembly configured to move the laser cutting head along a third linear path which is perpendicular to the first linear path. The second actuator assembly is configured to move a second counter mass along a fourth linear path which is parallel to the third linear path.

According to the present teachings, the afore or following mentioned systems can include a first side bearing disposed between the laser head and the first actuator assembly. The first side bearing is configured to allow the laser cutting head to move relative to the first actuator assembly in a direction perpendicular to the first linear path.

According to the present teachings, the afore or following mentioned systems, the laser head has a laser head center of gravity and the first and second counter masses have a first and second counter mass center of gravities. The laser head center of gravity and first and second counter mass center of gravities move on a first motion plane when on the laser head is moving in the first direction and the counter weight is moving in the second direction.

According to the present teachings, the afore or following mentioned systems can include a second side bearing disposed between the laser head and the second actuator assembly. The second side bearing is configured to allow the laser cutting head to move relative to the second actuator assembly in a direction perpendicular to the third linear path.

According to the present teachings, the afore or following mentioned systems further can include a controller configured to apply a signal to the first and the second actuator assemblies to move the laser head in one of a curvilinear and a circular path.

According to the present teachings, a robotic system is provided. The robotic system includes a robotic arm having ground and a first arm having a first end coupled to the ground. A coupling there between is provided which is configured to allow at least two axis of rotation and a second end. The robotic system further includes a second arm having a third end coupled to the second end with a coupling allowing at least two axis of rotation and a fourth end. The robotic arm has a resonant frequency and amplitude. The robotic system has an end effector for a laser head coupled to the fourth end. A first actuator assembly is coupled to the first coupler and is disposed between the laser head and the fourth end. The first actuator assembly has a first linear drive configured to move the laser cutting head along a first path. The first drive is coupled to a first counter mass is configured to move the first counter mass along a second path in a direction opposite the first direction. The system further has a second actuator assembly disposed between the fourth end and the laser head. The second actuator has a second linear drive coupled to the laser head and configured to move the laser head along a third path in a third direction. The second drive is coupled to a second counter mass and is configured to move the second counter mass in along a fourth path and in a direction opposite the third direction.

According to an alternate teaching, in each of the afore or following mentioned systems the first and second actuators can include ball-screw drives and stepper motors.

According to an alternate teaching of any of the afore or following mentioned systems, the first and second counter masses each have a mass is different than the mass of the laser cutting head.

According to an alternate teaching of any of the afore or following mentioned systems, the first and second paths are linear.

According to an alternate teaching of any of the afore or following mentioned systems, the first drive is configured to move the laser cutting head a first distance along the first path and the first drive is configured to move the first counter mass along the second path the second distance different than the first distance.

According to an alternate teaching of any of the afore or following mentioned systems, the first and second actuators are variable speed actuators.

According to an alternate teaching of any of the afore or following mentioned systems, the first and second actuators can be engaged simultaneously to move the laser head in a curvilinear path. Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 represents a robotic system having an end effector according to the present teachings;

FIG. 2 represents a perspective view of the end effector shown in FIG. 1;

FIG. 3 represents a bottom view of the end effector shown in FIG. 1;

FIG. 4 represents a sectional view of the end effector shown in FIG. 3;

FIG. 5 represents a sectional view of the end effector shown in FIG. 3;

FIGS. 6a and 6b represent a sectional view showing a drive mechanism of the end effector shown in FIG. 3;

FIG. 7 represents a sectional view showing an alternative drive mechanism of the end effector shown in FIGS. 3; and

FIG. 8 represents differences in cutting surfaces formed in a component when they system is actuated.

Corresponding reference numerals indicate corresponding parts throughout the several views of the drawings.

### DETAILED DESCRIPTION

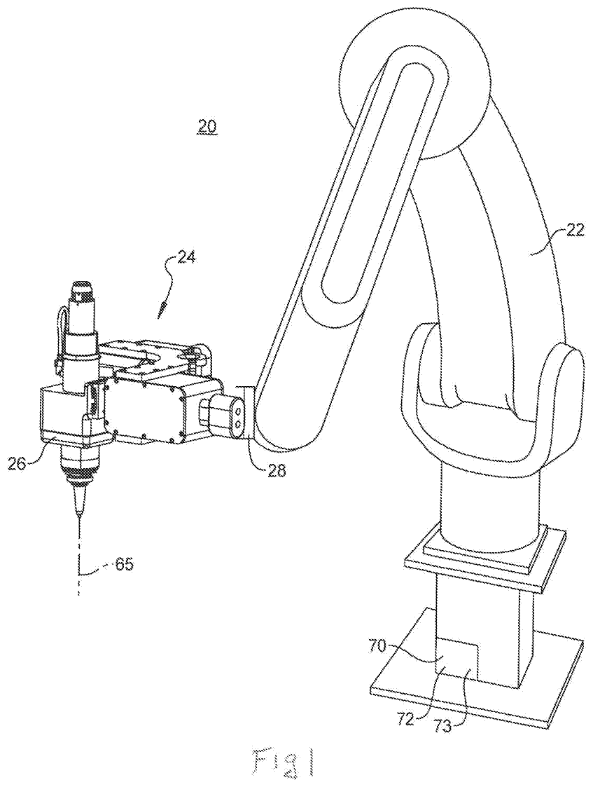

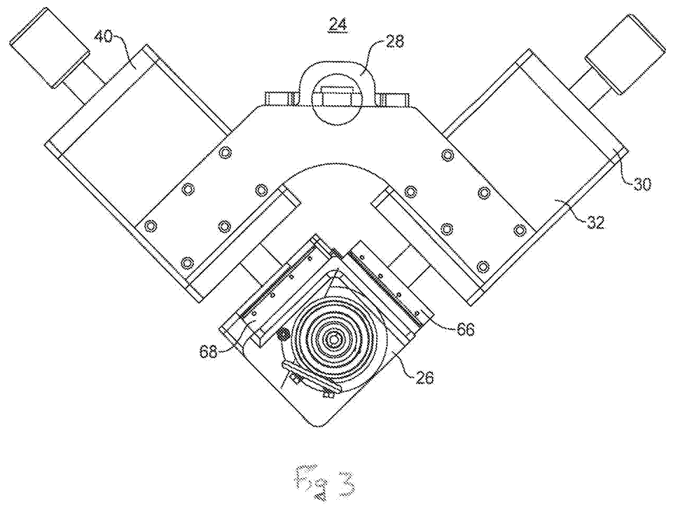

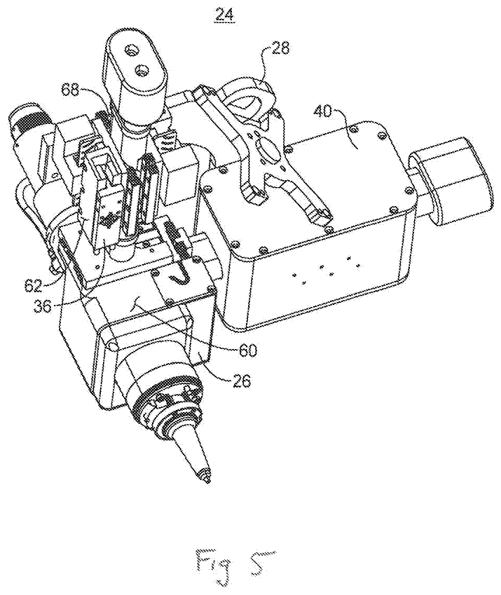

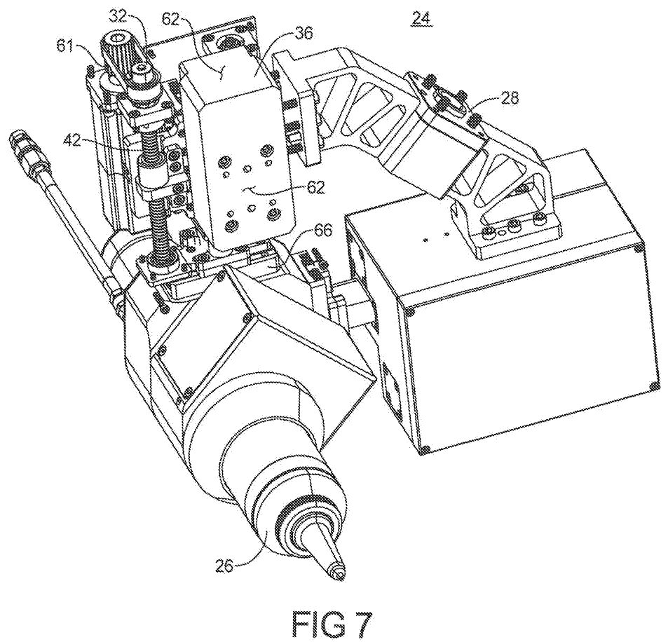

Example embodiments will now be described more fully with reference to the accompanying drawings. FIGS. 1-7 represent a robotic system 20 according to the present teachings. The robotic system 20 includes a robotic arm 22 and as robotic arm end effector 24 for a laser head 26 configured to drive the laser head 26 along a curved cutting path. The end effector 24 has a coupler 28 to couple the end effector 24 to the robotic arm 22 and a first actuator assembly 30 coupled to the first coupler 28. The first actuator assembly 30 has a first drive 32 coupled to the laser head 26. The first actuator assembly 30 is configured to move the laser head 26 along a first path 34.

As shown in FIG. 1, the robotic system 20, by way of a non-limiting example, includes a robotic arm 22 rotatably coupled to the ground. The coupling between the first arm and the ground is configured to allow at least two axis of rotation and a second end. The robotic system 20 further includes a second arm coupled to the first arm allowing at least two-axis of rotation. At an end of the second arm is the end effector 24 which supports the laser cutting head 26 producing a beam with a beam axis 65. As described below, the robotic arm 22 is controlled by a controller 70 having a computer 72 driven by a program 73. The robotic arm 22 has sympathetic resonant frequency which leads to sympathetic movement of the head at a particular amplitude.

The robotic system 20 has the end effector 24 for a laser head 26 coupled to the second arm. The first actuator assembly 30 has a first linear drive 32 configured to move the laser cutting head 26 along a first path. The first drive 32 is coupled to a first counter mass 36 is configured to move the first counter mass 36 along a second path in a direction opposite the first direction. The system 20 further has a second actuator assembly 40 disposed between the fourth end and the laser head 26. The second actuator 40 has a second linear drive 42 coupled to the laser head 26 which is configured to move the laser head 26 along a third path in a third direction. The second drive is coupled to a second counter mass 48 and is configured to move the second counter mass 48 in along a fourth path and in a direction opposite the third direction. Linear movement induced by these actuators combine to move the laser head in a curved path.

The first drive 32 is configured to move the laser cutting head 26 a first distance along the first path and the first drive is configured to move the first counter mass along the second path the second distance different than the first distance. Optionally, the first and second actuators are variable speed actuators which can be engaged simultaneously to move the laser head in a curvilinear path.

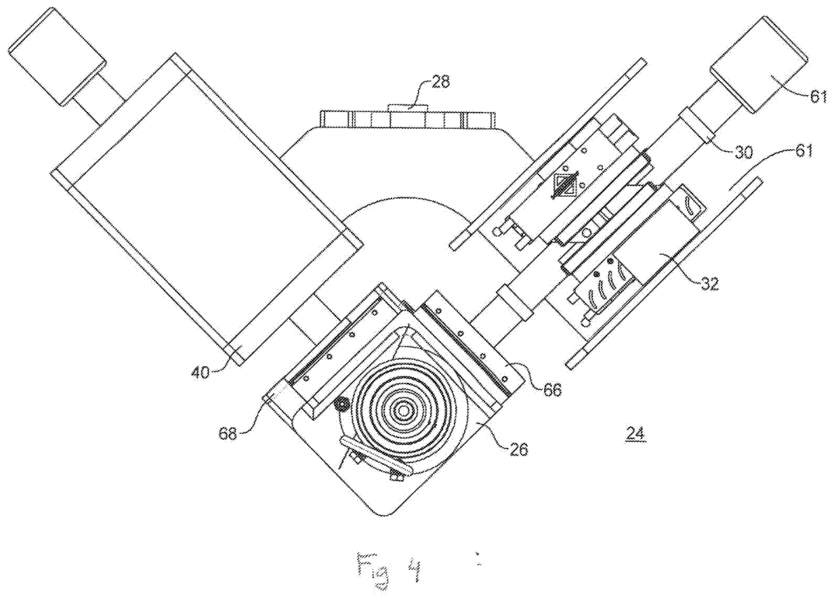

As shown in FIGS. 4-7, the first drive 32 is coupled to the first counter mass 36 through a threaded coupling and is configured to move the first counter mass 36 along a second path 38 in a direction opposite the first direction 32. The end effector 24 also has a second actuator assembly 40 coupled to the coupler 28. The second actuator 40 has a second drive 42 coupled to the laser head 26 which is configured to move the laser head 26, along a third path 44 in a third direction 46. The second drive 42 is coupled to the second counter mass 48 through a second threaded coupling and is configured to move the second counter mass 48 in along a fourth path 50 and in a direction 52 opposite the third direction 46.

The first drive 32 of the end effector 24 has first and second linear actuators 54, 56. These linear actuators can be constant or variable speed, allowing for a range of linear and curvilineal movement for the laser head 26. In this regard, the pitch of the treads of the drive can vary. These first and second linear actuators 54, 56 can be screw drives driven by the stepper motor or motors 58 either directly through gears, or by a belt drive 61.

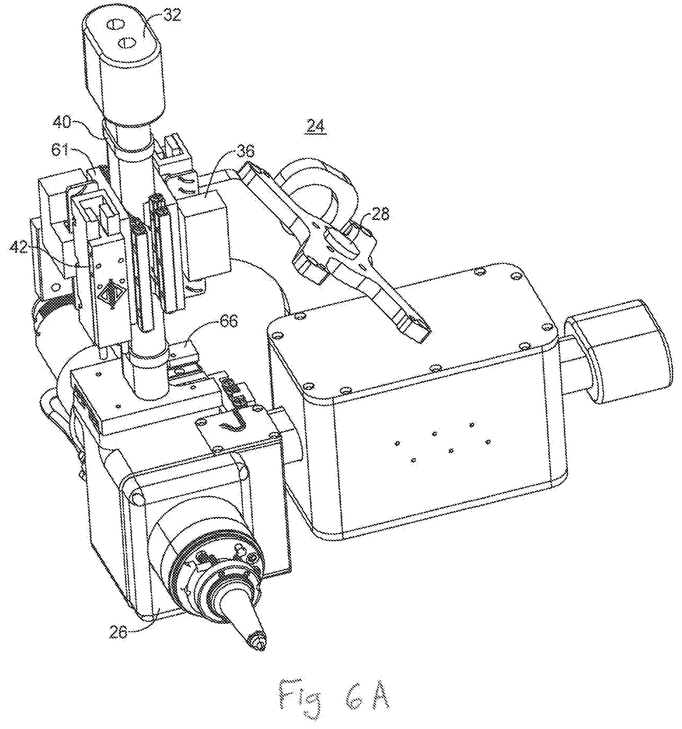

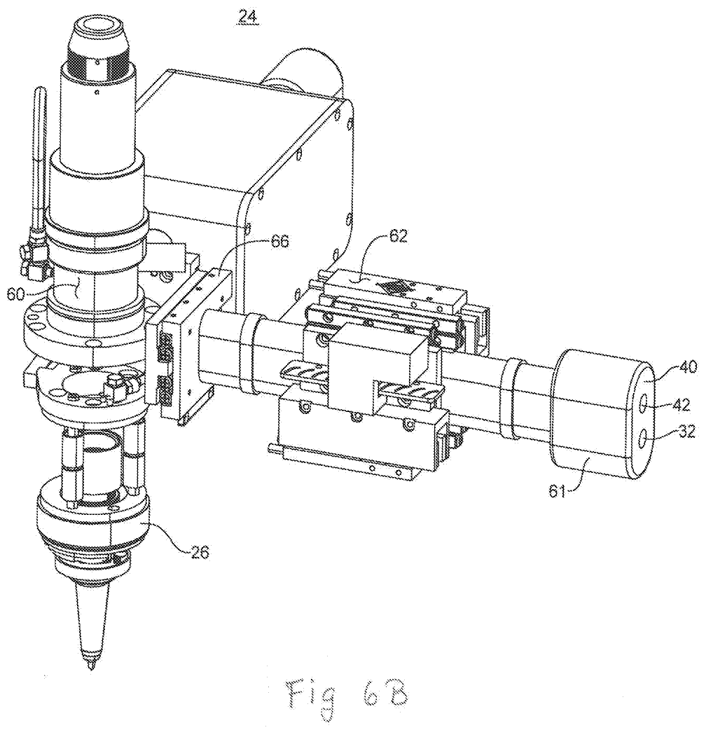

Alternatively, as shown in FIGS. 6A and 6B, a single stepper motor can be used to drive a single screw having a first pitch angle on a first half of the shaft, and a second opposite pitch on the second end of the shaft. The mass of the first or second counter masses 36, 48 can be equal or different than the mass of the laser cutting head. In the case when the mass is different than the laser head mass, the drive will be configured to move the masses at a velocity which is proportional to the mass differences. In this regard, should the mass be lower, the drives for the counter masses will accelerate the counter mass at a rate proportional to the F=m*a.

When the mass of the laser head and the counter mass are the same, the first drive 32 is configured to move the laser head 26 a first distance, velocity, or acceleration along the first path and the first actuator assembly 30 is configured to move the first counter mass 36 along the second path the first distance, velocity or acceleration. Alternatively, the first drive 32 can be configured to move the laser head 26 a first distance, velocity, or acceleration along the first path and the first drive is configured to move the first counter mass along the second path the second distance, velocity or acceleration different than the first distance, velocity or acceleration, depending on the mass of the counter mass 36. This can be accomplished by having driven screws having varying pitch, thread counts per length.

The laser head module 26 has a laser head center of gravity 60 and the first counter mass 36 has a first counter mass center of gravity 62. The laser head center of gravity 60 and first counter mass center of gravity 62 move on a first motion plane 64 when on the laser head 26 is moving in the first direction and the counter weight is moving in the second direction. Keeping the centers of gravity for the laser head and counter mass on the same plane reduces the amplitude of the vibration of the robotic arm 22 at its resonant frequency. The laser head 26 has a beam direction 65 which is generally perpendicular to this plane and the first, second, third, and fourth paths. While the first, second, third and fourth paths are linear, the resultant path of the laser head is curvilinear such as a circle or an arc.

Alternatively, the first actuator assembly is configured to move the laser head 26 in along a first linear path in a first direction and further configured to move first counter mass 36 in along a second linear path which is parallel to the first linear path in a second direction opposite first direction. The first actuator assembly can include a linear motor such as one of a screw drive, and a rack and pinion. The second actuator assembly 50 can be similarly configured to move the laser head 26 along a third linear path which is perpendicular to the first linear path. The second actuator assembly 50 is configured to move a second counter mass along a fourth linear path which is parallel to the third linear path. Both the first and second actuator's can be mounted on an L-shaped support bracket.

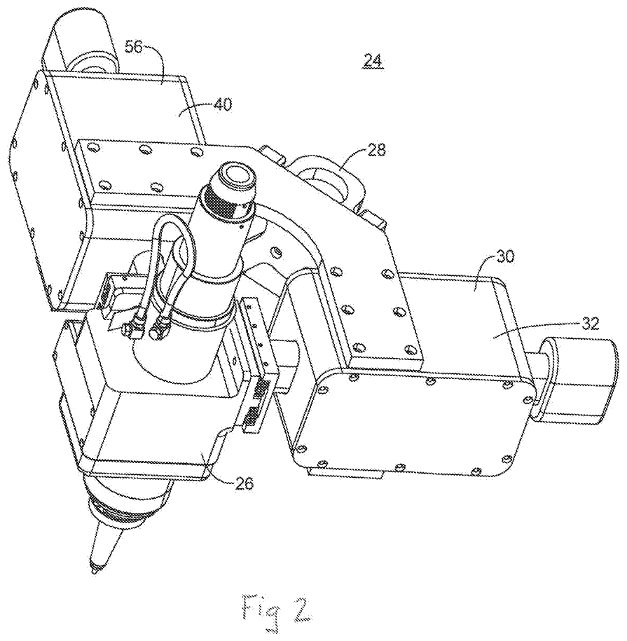

As seen in FIG. 2-7, the system a first side bearing 66 disposed between the laser head 26 and the first actuator assembly 30. The first side bearing 66 is configured to allow the laser head 26 to move relative to the first actuator assembly in a direction perpendicular to the first linear path upon application of forces from the second actuator assembly. Similarly, a second side bearing 68 is configured to allow the laser head 26 to move relative to the second actuator assembly in a direction perpendicular to the third linear path upon application of forces from the first actuator assembly.

The laser head 26 has a laser head center of gravity and the first and second counter masses have a first and second counter mass center of gravities. The laser head 26 center of gravity and first and second counter mass center of gravities move on a first motion plane when on the laser head is moving in the first direction and the counter weight is moving in the second direction. The system 20 can include a controller 70 configured to apply a signal to the first and the second actuator assemblies to move the laser head 26 in one of a curvilinear and a circular path.

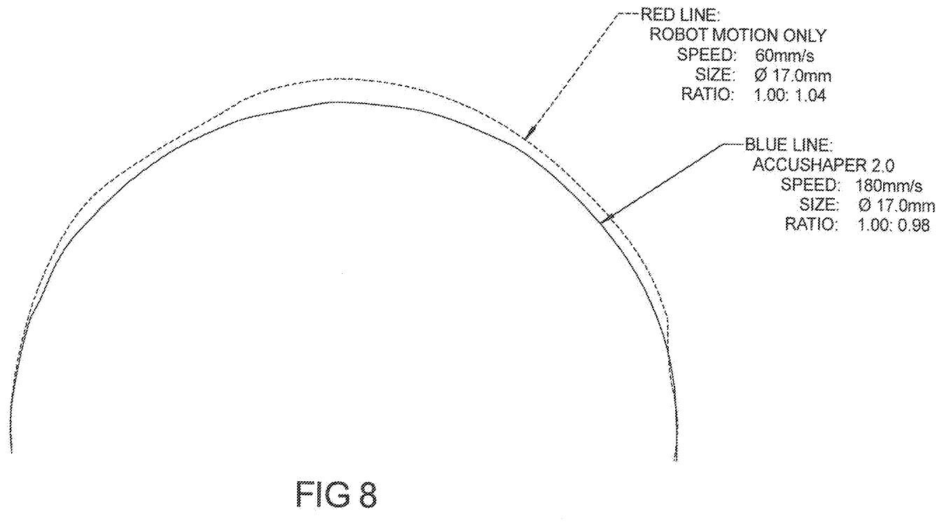

FIG. 8 depicts actual test data showing the formation of a hole in a metal plate with the end effector unactuated, and actuated. In the unactuated configuration, the hole is formed by moving the robot arm. As can be seen, the edge of the hole is shown having significant error. When the end effector is actuated, the amplitude of the sympathetic vibration in the robot arm (see FIG. 1) is reduced and the accuracy of the cut hole is increased.

Associated with the end effector has a specialized machine controller able to read instructions from a machine-readable medium and execute them in a processor (or controller). Specifically, the robotic system has a computer system within which instructions (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 73 (sequential or otherwise) that specify actions to be taken by that machine. Further, while only a single machine is illustrated, the term “machine” shall also be taken to include any collection of machines that individually or jointly execute instructions 324 to perform any one or more of the methodologies discussed herein.

The example computer system 72 includes one or more processors (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory, and a static memory, which are configured to communicate with each other via a bus. The computer system 72 may further include graphics display unit (e.g., a plasma display panel (PDP), a liquid crystal display (LCD), a projector, or a cathode ray tube (CRT)). The computer system may also include alphanumeric input device (e.g., a keyboard), a cursor control device (e.g., a mouse, a trackball, a joystick, a motion sensor, or other pointing instrument), a storage unit, a signal generation device (e.g., a speaker), and a network interface device, which also are configured to communicate via the bus.

The storage unit includes a machine-readable medium on which is stored instructions (e.g., software) embodying any one or more of the methodologies or functions described herein. The instructions (e.g., software) may also reside, completely or at least partially, within the main memory or within the processor (e.g., within a processor's cache memory) during execution thereof by the computer system, the main memory and the processor also constituting machine-readable media. The instructions (e.g., software) may be transmitted or received over a network via the network interface device.

Embodiments are described herein of various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment(s) is included in at least one embodiment. Thus, appearances of the phrases “in various embodiments,” “in some embodiments,” “in one embodiment,” or “in an embodiment,” or the like, in places throughout the specification, are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although at least one embodiment for a Visual Camouflage System, Research, Insights, Design, and Method of Manufacture has been described above with a certain degree of particularity, those skilled in the art could make numerous alterations to the disclosed embodiments without departing from the spirit or scope of this disclosure. Further embodiments of the present disclosure will be apparent upon review of the material. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the devices. It will be further appreciated that for conciseness and clarity, spatial terms such as “vertical,” “horizontal,” “up,” and “down” may be used herein with respect to the illustrated embodiments. Joinder references (e.g., affixed, attached, coupled, connected, and the like) are to be construed broadly and can include intermediate members between a connection of elements and relative movement between elements. As such, joinder references do not necessarily infer that two elements are directly connected and in fixed relationship to each other. It is intended that all matter contained in the above description or shown in the accompanying drawings shall be interpreted as illustrative only and not limiting.

Changes in detail or structure can be made without departing from the spirit of the disclosure as defined in the appended claims. Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A robotic arm end effector for a laser head coupled to a robotic arm comprising:
a coupler to couple the end effector to the robotic arm;
a first actuator assembly coupled to the first coupler, said first actuator having a first drive coupled to the laser cutting head and configured to move the laser cutting head along a first path, said first drive being coupled to a first counter mass and being configured to move the first counter mass along a second path in a direction opposite the first direction; and
a second actuator assembly coupled to the coupler, said second actuator having a second drive coupled to the laser head and configured to move the laser head along a third path in a third direction, said second drive being coupled to a second counter mass and being configured to move the second counter mass in along a fourth path and in a direction opposite the third direction.

2. The robotic arm end effector according to claim 1 wherein the first drive comprises first and second linear actuators.

3. The robotic arm end effector according to claim 2 wherein the first and second linear actuators are ball-screw drives.

4. The robotic arm end effector according to claim 1 wherein the first and second drives comprise stepper motors.

5. The end effector according to claim 1 wherein the mass of the counter mass is equal to the mass of the laser cutting head.

6. The end effector according to claim 1 wherein the first and second paths are linear.

7. The end effector according to claim 1 wherein the first drive is configured to move the laser cutting head a first distance along the first path and the first drive is configured to move the first counter mass along the second path the first distance.

8. The end effector according to claim 1 wherein the first drive is configured to move the laser cutting head a first distance along the first path and the first drive is configured to move the first counter mass along the second path the second distance different than the first distance.

9. The end effector according to claim 1 wherein laser head module has a laser head center of gravity and the first counter mass has a first counter mass center of gravity, said laser head center of gravity and first counter mass center of gravity moving on a first motion plane when on the laser head is moving in the first direction and the counter weight is moving in the second direction.

10. The robotic arm end effector according to claim 1 wherein the laser head has a beam direction, said first, second, third, and fourth paths are perpendicular to the beam direction.

11. A robotic arm end effector comprising:
a laser head;
a drive mechanism having a first actuator assembly, said first actuator assembly configured to move the laser head in along a first linear path in a first direction and further configured to move first counter mass in along a second linear path which is parallel to the first linear path in a second direction opposite first direction.

12. The robotic arm end effector according to claim 11 wherein the drive mechanism comprises a stepper motor and the first actuator assembly is one of a ball screw drive, a rack and pinion.

13. The robotic arm end effector according to claim 11 further comprising a second actuator assembly configured to move the laser cutting head along a third linear path which is perpendicular to the first linear path, said second actuator assembly being configured to move a second counter mass along a fourth linear path which is parallel to the third linear path.

14. The robotic arm end effector according to claim 13 further comprising a first side bearing disposed between the laser head and the first actuator assembly, said first side bearing configured to allow the laser cutting head to move relative to the first actuator assembly in a direction perpendicular to the first linear path.

15. The robotic arm end effector according to claim 14 wherein laser head has a laser head center of gravity and the first and second counter masses have a first and second counter mass center of gravities, said laser head center of gravity and first and second counter mass center of gravities move on a first motion plane when on the laser head is moving in the first direction and the counter weight is moving in the second direction.

16. The robotic arm end effector according to claim 14 further comprising a second side bearing disposed between the laser head and the second actuator assembly, said second side bearing configured to allow the laser cutting head to move relative to the second actuator assembly in a direction perpendicular to the third linear path.

17. The robotic arm end effector according to claim 13 further comprising a controller configured to apply a signal to the first and the second actuator assemblies to move the laser head in a circular path.

18. The robotic arm end effector according to claim 16 wherein the laser has a beam direction, said first, second, third, and fourth paths are perpendicular to the beam direction.

19. A robotic system comprising:
a robotic arm having ground, a first arm having a first end coupled to the ground with a coupling allowing at least two axis of rotation and a second end, a second arm having a third end coupled to the second end with a coupling allowing at least two axis of rotation and a fourth end, said robotic arm having a resonant frequency and amplitude;
an end effector for a laser head coupled to the fourth end;
a first actuator assembly coupled to the first coupler, said first actuator disposed between the laser head and the fourth end having a first linear drive configured to move the laser cutting head along a first path, said first drive being coupled to a first counter mass and being configured to move the first counter mass along a second path in a direction opposite the first direction; and
a second actuator assembly disposed between the fourth end and the laser head, said second actuator having a second linear drive coupled to the laser head and configured to move the laser head along a third path in a third direction, said second drive being coupled to a second counter mass and being configured to move the second counter mass in along a fourth path and in a direction opposite the third direction.

20. The robotic system according to claim 19 wherein the first and second actuators comprise ball-screw drives, stepper motors.

21. The robotic system according to claim 19 herein the first and second counter masses each have a mass is equal to the mass of the laser cutting head.

22. The end effector according to claim 19 wherein the first and second paths are linear.

23. The end effector according to claim 19 wherein the first drive is configured to move the laser cutting head a first distance along the first path and the first drive is configured to move the first counter mass along the second path the second distance different than the first distance.

24. The robotic arm end effector according to claim 19 wherein the first and second actuators are variable speed actuators.

25. The robotic arm end effector according to claim 19 wherein the first and second actuators can be engaged simultaneously to move the laser head in a curvilinear path.
